(19) United States
(12) Patent Application Publication
(10) Pub. No.: US 2002/0087739 A1
(43) Pub. Date: Jul. 4, 2002

(54) Compile time optimization for reducing network traffic in corba systems

(76) Inventor: Sam Mazza, Fort Lee, NJ (US)

Correspondence Address: PILLSBURY WINTHROP, LLP, P.O. BOX 10500, MCLEAN, VA, 22102, US

(21) Appl. No.: 09/749,609

(22) Filed: Dec. 28, 2000

(51) Int. Cl. G06F 9/46; G06F 9/00

(52) U.S. Cl. 709/316

(57) ABSTRACT

A method is provided for to packing data. A plurality of attribute specifications is obtained as input. Each of the attribute specifications includes an attribute name and an attribute type. Based on the input attribute specifications, a permutation of the attribute specifications is generated.

### COPYRIGHT NOTICE

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND OF THE INVENTION

1. Field of the Invention

The present invention, in certain respects, relates to object oriented distributed computing. In other respects, the present invention relates to packing data that is to be transmitted over a packet based network.

2. Description of Related Art

Programming paradigm is becoming more and more object oriented. In distributed computing, objects are often distributed as well. In client-server applications, objects reside on a server and clients request needed services from the server objects whenever necessary. FIG. 1 (Prior Art) shows an object-oriented distributed computing system 100. A server 110 houses objects, such as, for example, a ‘Shopping-Cart’, in a server database 120. A client, client i . . . client n, can send requests to server 110 for object services. Clients connecting to a server can be different types of computers operating on different platforms. Examples are workstations running on Unix, PCs running on Windows NT, such as client i 130 shown in FIG. 1, or different hand held devices such as a Palm Pilot or a wireless phone, such as client n 140 shown in FIG. 1, running on some operating system.

FIG. 1 shows one example of how object service can be requested and executed in a distributed computing environment. The two clients, client i 130 and client n 140 in FIG. 1 request services from server 110 related to the object called “Shopping-Cart” which is stored in server database 120. Each client needs a different instance of the “shopping cart” object. Upon such requests, the server 110 generates individual instances of the object and sends them to respective clients 130 and 140. These two instances of the shopping cart object may further request different services and each has the capabilities of the shopping-cart object, for example, “adding” and “removing” merchandises to/from the “shopping cart”. For example, in FIG. 1, client 130 requests to add one more item to its shopping cart while client 140 requests to check out the items in its shopping cart. The returned result from server 110 for the client 130 is an expanded list of items in the shopping cart. The returned result from server 110 for client 140 is the total amount charged to the client.

These services are encapsulated within object “Shopping Cart” and implemented as the methods of the object. To request services, a client remotely invokes the methods that perform desired functionalities on the object. Therefore, methods are the means for a user to manipulate the object. To invoke them remotely, necessary parameters or other types of data have to be transmitted over the network between the client and the server. The reverse is also true.

As an encapsulated entity, each object has a set of ‘attributes’ and a set of ‘methods’ associated with it. An attribute may be a simple variable or a more complicated structure. The “encapsulation” of an object component occurs by hiding the actual implementation. Such an object model provides a strong separation of “interface” from “implementation”. Interface refers to what is exposed to users. Implementation refers to how an object is realized. Implementation is platform dependent. In a distributed computing setting where objects may reside on heterogeneous computers, one challenge is how to make the object interface platform independent.

An Object Management Group (OMG) is established to develop standards that enable efficient management and communication among heterogeneous object components. For example, new standards such as CORBA IDL (Common Object Request Brokerage Architecture—Interface Definition Language) provide a language-neutral and location-neutral messaging interface for component integration. The CORBA IDL standard is intended to serve as an interface specification or “contract” between different subsystems in a distributed computing scenario. Users define desired object interfaces using IDL, which then gets compiled to generate a skeleton for the server and a stub for the client. This is explained with reference to FIG. 2.

In FIG. 2, via system 200, an object interface is first specified using an interface definition language (IDL) at act 210. The specification is then compiled at act 220. The compilation generated two output: a server skeleton 230 and a client stub 240, both complying with CORBA architecture. Through the client stub 240, a client can request services from or invoke methods of an object (server) via a standard interface. The request is an event and carries the information (e.g., the object reference on the server, the method to be called, and the actual parameters used to call the method) necessary to complete the invocation. During this invocation process, the implementation of the object on the server side is no concern to the client (implementation independent).

Data exchange usually occurs between a client stub and a server skeleton. For example, when a client invokes a distributed operation on a server, it transfers the operation data to the server. To be platform independent, the data has to be packed in a commonly understandable format. To achieve that, CORBA specifies the representation of encapsulated data structures as an octet sequence and accordingly defines the rules in CDR (Common Data Representation) transfer syntax so that IDL data types can be formatted into an octet sequence.

The transformation of an interface specification to a platform independent representation, such as an octet sequence, is illustrated in FIG. 3. In FIG. 3, interface specifications 310 are transformed into octet sequences 330, via CDR transfer syntax 320. An octet is an 8-bit value that undergoes no marshalling. An octet sequence is a list of these octets with a well-defined beginning. The octets in such a sequence are indexed in a similar way as in an array in C++.

When the data within an encapsulation is transformed into an octet sequence, the boundary between different pieces of data has to be aligned properly. The alignment boundaries depend on data types and are calculated with octet indices. A typical rule for aligning boundaries is: a mod n=0, where a is the byte address of the data type being accessed and n is the size of the data type in bytes. That is, a datum of size n must start at an index in an octet sequence that is multiple of n. For example, a short variable, which is two bytes in size, has to start at indices 0, 2, 4, . . . 10, 12 . . .

In CDR, n={1,2,4,8}. With the above-mentioned rule (a mod n), padding has to be added whenever necessary. The total number of bytes used for padding is directly related to the order in which the variables are defined. Consequently, this order can introduce degradation in both network performance (because of the higher bandwidth requirement) and memory usage, due to required padding. Current state of the art such as IDL compiler generates an octet sequence in which variables are packed in the same order as they appear in the interface specifications.

There is a need for an intelligent mechanism, capable of analyzing a user defined interface and optimizing the order in which attributes are defined to yield the most efficient packing and minimum padding.

### BRIEF DESCRIPTION OF THE DRAWINGS

The present invention is further described in the detailed description with follows, by reference to the noted drawings by way of non-limiting exemplary embodiments, in which like reference numerals represent similar parts throughout the several views of the drawings, and wherein:

FIG. 1 (Prior Art) is a schematic diagram showing exemplary client-server interactions in a distributed object-oriented computing arrangement;

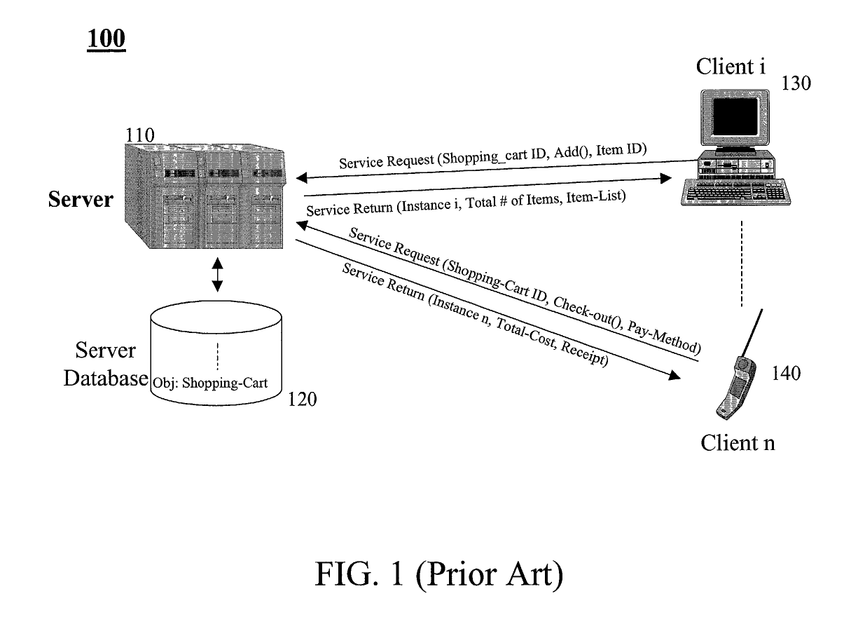

FIG. 2 (Prior Art) describes the state of the art that enables distributed object-oriented communications;

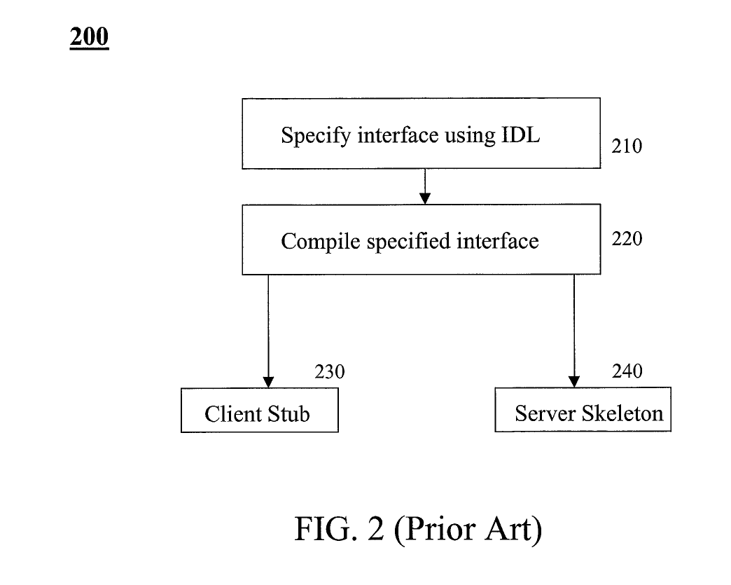

FIG. 3 (Prior Art) shows an example of translating interface specifications into a platform independent data representation;

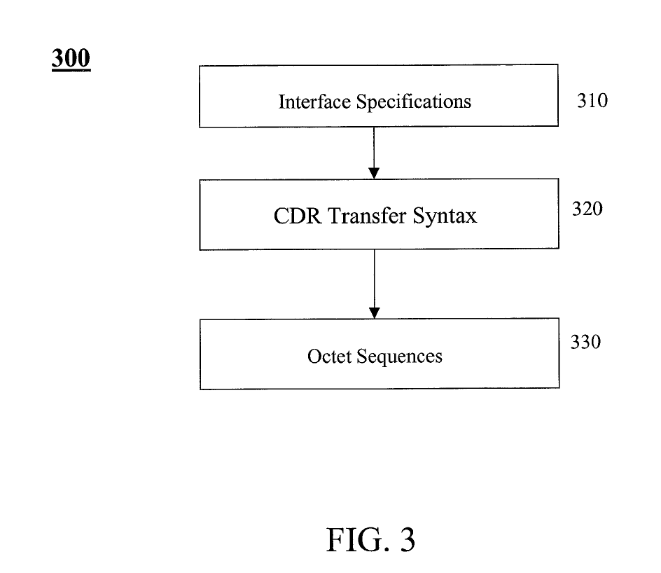

FIG. 4 is a high level block diagram of an exemplary embodiment of the invention;

FIG. 5 is a high level diagram of an optimizer;

FIG. 6 is a flowchart of a grouping mechanism;

FIG. 7 is a flowchart of a mechanism to assign type sizes to type groups;

FIG. 8 is a flowchart for calculating a type size for a structure; and

FIG. 9 is a flowchart for sorting type groups based on their size values.

### DETAILED DESCRIPTION

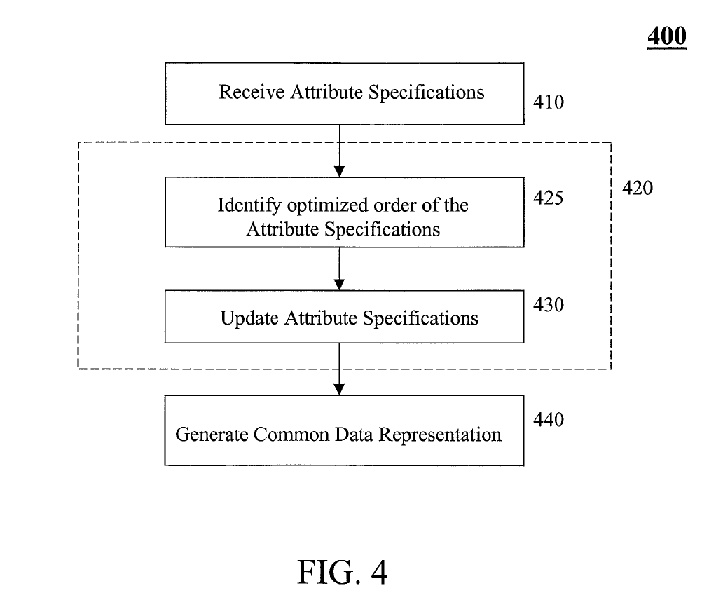

An exemplary embodiment of the invention is described herein with reference to FIGS. 4-9. Related terminology is explained first.

“Interface specifications” of an object refers to descriptions written in a language of standard syntax (e.g., IDL) that define certain aspects associated with the object. These aspects serve as the interface between the object and the users who manipulate the object and include the attributes of the object or the methods of the object through which the objects can be manipulated.

“Attribute specifications” refers to the specific part of interface specifications where object attributes are defined. An object attribute can be simply a primitive variable or a more complex or non-primitive structure. An object attribute may be specified by its attribute name and its type. For example, “LONG A;”, is an attribute specification, meaning attribute or variable “A” is a LONG type. A non-primitive object attribute, usually a structure, has members that constitute the structure. A simplest case of a non-primitive attribute is an array. A more complex example can be a structure that represents a personal medical record which contains person's name (character type), blood test result (float type), and allergy shot history (an embedded structure). A member of a structure may be another structure. Ultimately, a structure may be recursively decomposed into a set of primitive variables each of which has a name and a primitive type.

A “type group” is defined as a group of attributes that all have the same type. Each type group is associated with a number or “type size” defined by the byte size of its members. For example, the “type size” of a LONG type group is 4 because a LONG variable occupies 4 bytes.

A “primitive type” is a simple variable type, such as short or long, whose type size is well defined and straightforward. A “non-primitive type” corresponds to structures whose type size depends on the underlying composition of the structure.

FIG. 4 is a high level block diagram of an exemplary embodiment of the invention. Attribute specifications are first received at 410. To generate a platform independent representation of the attributes, padding is often needed to conform to the translation rules. Since the degree of padding affects bandwidth, memory, and speed performance, it is desirable to reduce the amount of padding. The present invention provides a method to optimize the order of the attributes so that the padding can be minimized. The optimization is performed at step 420.

The optimization, performed at 420, comprises identifying an optimized ordering of the attribute specifications, performed at act 425, and updating the attribute specifications, at act 430, according to the identified new order. This new version of the specifications is a permutation of the original version. Finally, based on the updated attribute specifications, platform independent representations for the attributes are generated at act 440.

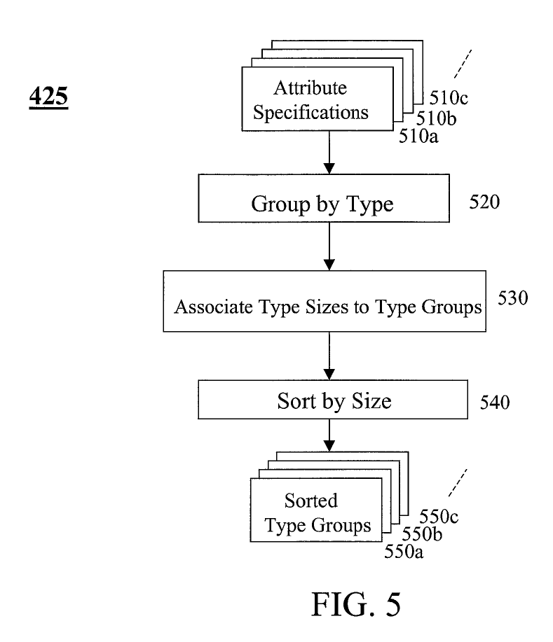

FIG. 5 describes the mechanism 500 that identifies the new ordering of the attributes. Given a set of attribute specifications at 510a, 510bb, 510c, . . . , the attributes are first grouped into type groups at act 520. Primitive attributes (simple variables) can be directly classified into different types. Non-primitive attributes are structures that may be grouped according to their names.

Each type group may be assigned, at act 530, a type size, indicating the number of bytes each attribute in the underlying type group occupies. The type groups are then sorted, at act 540, according to their corresponding type sizes. The sorting is performed according to the descending order of the values of the type sizes and yields a new ordering of the input attribute specifications (or permutation) 550a, 550b, 550c . . .

As an illustration, the following example demonstrates how an input list of attribute specifications may be transformed into a new list of attribute specifications so that the new list yields minimum padding. Given the following input list of attribute specifications:

CHAR c1;

LONG LONG 111;

CHAR c2;

SHORT s1;

CHAR c3;

LONG 11;

the grouping, performed at act 520, yields the following:

CHAR group (c1, c2, c3);

LONG LONG group (111);

SHORT group (s1);

LONG group (11).

Each of the type groups is then assigned, at act 530, a type size, which may be, for example, defined as the number of bytes that any instance of that type occupies. In the above example, the type sizes assigned to the groups illustrated above may be:

CHAR group→1;

LONG LONG group→8;

SHORT group→2;

LONG group→4.

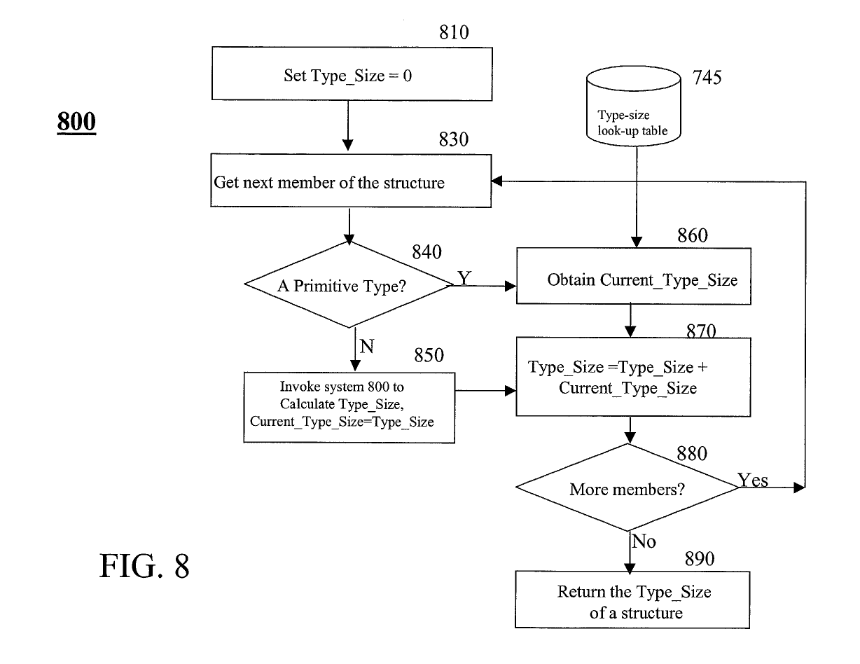

The calculation of the type size for a non-primitive type (structure) may be more complicated. It can be defined as, for example, the minimum number of bytes that any member of the same structure occupies. The calculation of a minimum number of bytes is explained below with reference to FIG. 8.

Once every type group, primitive or non-primitive, is assigned a type size, the type groups are sorted, at act 540, based on the values of their type sizes in a descending order. The order of the type groups after sorting for the above example is (LONG LONG, LONG, Hi SHORT, CHAR), which defines a corresponding new order of the attributes (111, 11, s1, c1, c2, c3). This new order is a permutation of the input attribute specifications (c1, 111, c2, s1, c3, 11). The new order is optimal in the sense that it yields a minimum padding which, consequently, leads to a shortest octet sequence.

The optimality can be illustrated by using the same example. Assume a commonly used padding rule is employed: a mod n, where a is the address of an attribute and n is its byte size. Based on this rule, the packing of the attribute specifications in the original order yields an octet sequence of a total of 28 bytes. Specifically,

c1 occupies one byte;

7 bytes of padding in order for 111 to starts at index 8;

111 takes 8 bytes;

c2 takes 1 byte;

1 byte of padding so that s1 can starts at an even index;

s1 takes 2 bytes;

c3 takes 1 byte;

3 bytes of padding is added;

11 takes 4 bytes.

Packing the optimized list of attribution specifications (111, 11, s1, c1, c2, c3), it leads it) to an octet sequence of 17 bytes due to the fact that there is a minimum amount of padding (zero in this example). Specifically,

111 occupies 8 bytes;

11 occupies 4 bytes;

s1 occupies 2 bytes;

c1 occupies 1 byte;

c2 occupies 1 byte;

c3 occupies 1 byte.

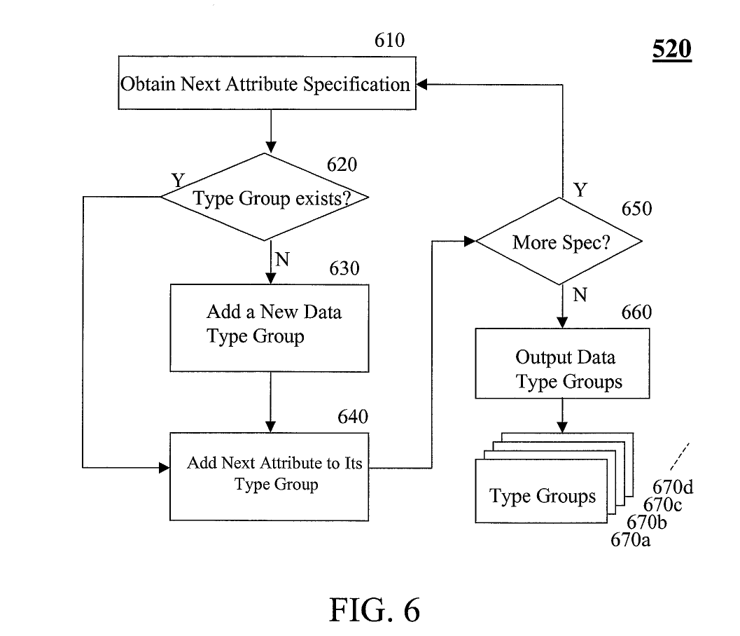

FIG. 6 shows a flowchart for the process of forming type groups (act 520 in FIG. 5). An attribute specification is obtained first at act 610. If the corresponding type group already exists, determined at act 620, the attribute is simply added to the corresponding type group at act 640. If its type group does not yet exist, a new type group is formed, at act 630, and then the attribute is added, as the first element, to the newly formed type group at act 640. This process continues until, determined at act 650, all the attributes have been classified into a type group. The process then outputs, at act 660, a set of type groups 670a, 670b, 670c . . .

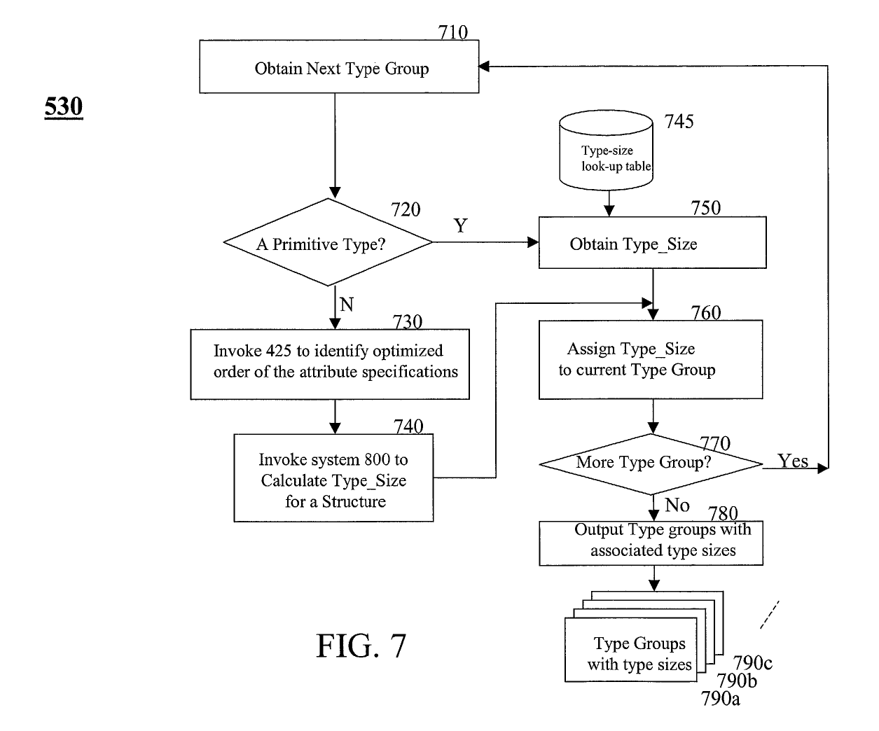

The process of associating a type size to each type group (act 530 in FIG. 5) is illustrated in FIG. 7. For each type group, if it is a primitive type, determined at act 720, its associated type size may be predefined. In this case, a type-size look-up table that records, for example, the correspondences between different primitive types and sizes may be stored in an accessible and retrievable storage 745. With such a table, a simple look-up operation to the table retrieves a type size with respect to a given primitive type. In FIG. 7, a type size for a primitive type group can be obtained at act 750 and assigned to the underlying type group at act 760. If a group is a non-primitive type, the type group corresponds to a structure.

A structure has its own internal attributes or members that are specified in some order. The type size for a structure may be derived using two approaches. One approach is to count the total number of bytes occupied by its members based, directly, on its original specification without any optimization. The type size obtained this way usually will not be minimal due to the non-optimal ordering of the members within the structure.

Alternatively, an optimal type size for a structure may be derived by optimizing the internal ordering of its members prior to counting the total number of bytes occupied. FIG. 7 describes the process using this approach. The strategy of optimizing the internal sttribute ordering of a structure is based on the same observations that motivated the present invention. As a structure may embed deeper structures, the optimization may be recursive.

In FIG. 7, to obtain an optimal type size for a structure, a recursive optimization is performed at act 730. Since the attribute specifications within a structure are in principle same as the attribute specifications at its parent level, the attribute specifications internal to a structure may be optimized using the same mechanism shown in FIG. 5. Therefore, at act 730, the process 425 is invoked to identify the optimal ordering of the attributes. The deeper a structure embeds internal structures, the deeper the recursion is.

The recursive processing at act 730 produces an optimized ordering of the members of the structure. The type size corresponding to the optimized ordering is then computed, at act 740. The derived type size for the structure type group is then assigned to the type group at act 760. The processing continues until, determined at act 770, all the type groups have been assigned a type size. Type groups with associated type sizes 790a, 790b, 790c . . . are generated at act 780.

FIG. 8 is a flowchart for a process 800 that computes a type size for a structure whose internal attributes have been optimized with respect to the ordering. Initially, the overall type size is set to zero at act 810. Since the structure is optimized, the overall size is obtained by simply accumulating the byte sizes of each and every member of the structure. Depending on the composition of the structure, the accumulation process may be recursive.

An attribute or a member of a structure is first obtained at act 830. If the next member or attribute is of a primitive type, determined at act 840, its type size may be retrieved, at act 860, from a type-size look-up table 745. The retrieved size is added, at act 870, to the overall structure type size.

When the next member is itself a structure, determined at act 840, recursion is necessary. In this case, process 800 is recursively invoked at act 850 to calculate the type size of the member structure. Upon the return of the recursive invocation, the resulted type size for the member structure is added to the overall type size at 870. This process continues until, determined at act 880, all the members, primitive and non-primitive, have been enumerated. The overall type size for the structure is output at act 890.

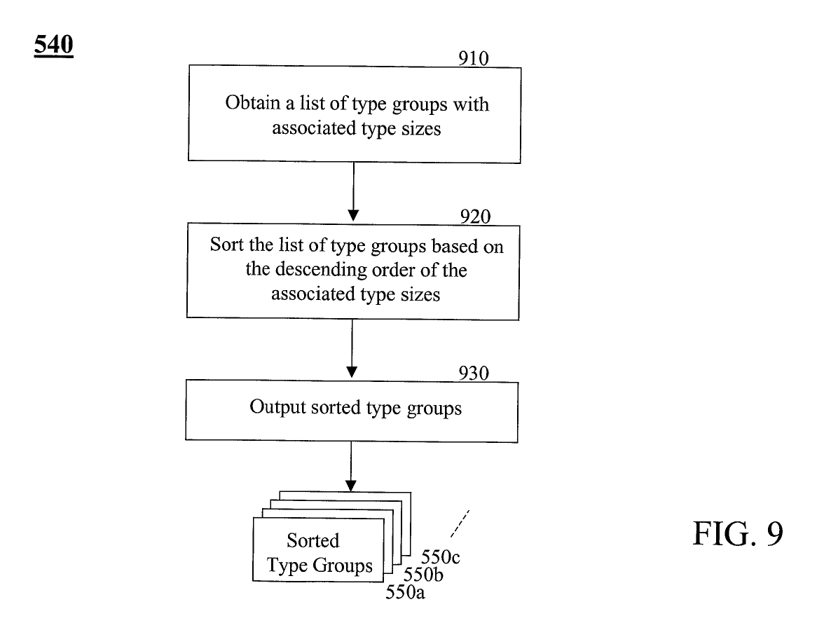

FIG. 9 describes the process 540 in which a list of type groups are sorted based on their associated type size values. A list of type groups is obtained at act 910. Each of the type groups is associated with a type size. Based on the values of the type sizes, the type groups are sorted, at act 920, according to the descending order of the type size values. This yields a list of sorted type groups, 550a, 550b, 550c . . . , which are output at act 930.

The processing described above may be performed by a general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method comprising:
obtaining a plurality of attribute specifications, each of said attribute specifications including an attribute name and an attribute type; and
generating a permutation of said plurality of attribute specifications.

2. The method according to claim 1, wherein said generating further comprises:
grouping said plurality of attribute specifications into type groups, each of said type groups containing at least one attribute of same said attribute type;
associating each of said type groups with a corresponding type size; and
sorting said type groups in an descending order based on the value of said corresponding type size.

3. The method according to claim 2, wherein said associating further comprises:
determining said corresponding type size for a type group; and
assigning said corresponding type size to said type group.

4. The method according to claim 3, wherein said determining includes:
obtaining said corresponding type size from a set of pre-defined primitive type sizes if the attribute type of said type group is a primitive type;
extracting a plurality of internal attribute specifications from said type group if the attribute type of said type group is a non-primitive type, each of said internal attribute specifications including an attribute name and an attribute type; and
generating a permutation of said plurality of internal attribute specifications; and
computing said corresponding type size of said type group by counting the total number of bytes occupied by said permutation of said plurality of internal attribute specifications.

5. The method according to claim 4, wherein said set of pre-defined primitive type sizes includes the type size definitions of C++.

6. The method according to claim 4, wherein said set of pre-defined primitive type sizes includes the type size definitions of Java.

7. A medium having information recorded thereon, such that when said information is read and executed by a computer, the computer is caused to:
obtain a plurality of attribute specifications, each of said attribute specifications including an attribute name and an attribute type; and
generate a permutation of said plurality of attribute specifications.

8. The medium of claim 7, wherein said information recorded on said medium further causes said computer to:
group said plurality of attribute specifications into type groups, each of said type groups containing at least one attribute of same said attribute type;
associate each of said type groups with a corresponding type size; and
sort said type groups in an descending order based on the value of said corresponding type size.

9. The medium of claim 8, wherein said information recorded on said medium further causes said computer to:
determine said corresponding type size for a type group; and
assign said corresponding type size to said type group.

10. The medium of claim 9, wherein said information recorded on said medium further causes said computer to:
obtain said corresponding type size from a set of pre-defined primitive type sizes if the attribute type of said type group is a primitive type;
extract a plurality of internal attribute specifications from said type group if the attribute type of said type group is a non-primitive type, each of said internal attribute specifications including an attribute name and an attribute type; and
generate a permutation of said plurality of internal attribute specifications; and
compute said corresponding type size of said type group by counting the total number of bytes occupied by said permutation of said plurality of internal attribute specifications.
